(19) United States
(12) Patent Application Publication
(10) Pub. No.: US 2025/0310791 A1
(43) Pub. Date: Oct. 2, 2025

(54) ENHANCING 5G COVERAGE OPTIMIZATION

(71) Applicant: T-MOBILE INNOVATIONS LLC, Overland Park, KS (US)

(72) Inventors: Krunal Mansukhlal MODASIYA, Aldie, VA (US); Pawankumar C. NARANG, Ashburn, VA (US); Murali Krishnan GOVINDAN, Ashburn, VA (US)

(21) Appl. No.: 18/620,358

(22) Filed: Mar. 28, 2024

(51) Int. Cl. H04W 24/02; H04W 16/22; H04W 16/28

(52) U.S. Cl. CPC H04W 24/02; H04W 16/22; H04W 16/28

(57) ABSTRACT

Systems and methods are provided for enhancing 5G coverage optimization. The specific antenna model name for each antenna is received at an optimization engine. The optimization engine identifies a remote electrical tilt (RET) corresponding to each antenna. The antenna model name and the RET angle value for each antenna are dynamically associated in a data store. Based on the antenna model name and the RET angle value, the optimization engine can predict real-time coverage provided by the antenna.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for enhancing 5G coverage optimization. More particularly, in aspects set forth herein, systems and methods enable a node to automatically retrieve a specific antenna model name for each antenna installed at the node. The specific antenna model name for each antenna is received at an optimization engine. The optimization engine identifies a remote electrical tilt (RET) corresponding to each antenna. The antenna model name and the RET angle value for each antenna are dynamically associated in a data store. Based on the antenna model name and the RET angle value, the optimization engine can predict real-time coverage provided by the antenna.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an example of a network environment in which implementations of the present disclosure may be employed;

FIG. 2 depicts an example optimization engine, in accordance with aspects herein;

FIG. 3 depicts a flow diagram of a method of enhancing 5G coverage optimization, in accordance with aspects herein; and

FIG. 4 depicts a diagram of an exemplary computing environment suitable for use in implementations of the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:

| | |
|---|---|
| 3G | Third-Generation Wireless Technology |
| 4G | Fourth-Generation Cellular Communication |
| | System |
| 5G | Fifth-Generation Cellular Communication System |
| 6G | Sixth-Generation Cellular Communication System |
| AI | Artificial Intelligence |
| CD-ROM | Compact Disk Read Only Memory |
| CDMA | Code Division Multiple Access |
| eNodeB | Evolved Node B |
| GIS | Geographic/Geographical/Geospatial Information |
| | System |
| gNodeB | Next Generation Node B |
| GPRS | General Packet Radio Service |
| GSM | Global System for Mobile communications |
| iDEN | Integrated Digital Enhanced Network |
| DVD | Digital Versatile Discs |
| EEPROM | Electrically Erasable Programmable Read Only |
| | Memory |
| LED | Light Emitting Diode |
| LTE | Long Term Evolution |
| MIMO | Multiple Input Multiple Output |
| MD | Mobile Device |
| ML | Machine Learning |
| PC | Personal Computer |
| PCS | Personal Communications Service |
| PDA | Personal Digital Assistant |
| PDSCH | Physical Downlink Shared Channel |
| PHICH | Physical Hybrid ARQ Indicator Channel |
| PUCCH | Physical Uplink Control Channel |
| PUSCH | Physical Uplink Shared Channel |
| RAM | Random Access Memory |
| RET | Remote Electrical Tilt |
| RF | Radio-Frequency |
| RFI | Radio-Frequency Interference |
| R/N | Relay Node |
| RNR | Reverse Noise Rise |
| ROM | Read Only Memory |
| RSRP | Reference Signal Receive Power |
| RSRQ | Reference Signal Receive Quality |
| RSSI | Received Signal Strength Indicator |
| SINR | Transmission-to-Interference-Plus-Noise Ratio |
| SNR | Transmission-to-noise ratio |
| SON | Self-Organizing Networks |
| TDMA | Time Division Multiple Access |
| TXRU | Transceiver (or Transceiver Unit) |
| UE | User Equipment |
| UMTS | Universal Mobile Telecommunications Systems |
| WCD | Wireless Communication Device (interchangeable |
| | with UE) |

Further, various technical terms are used throughout this description. An illustrative resource that fleshes out various aspects of these terms can be found in Newton's Telecom Dictionary, 32^{nd} Edition (2022).

By way of background, a traditional telecommunications network employs a plurality of base stations (i.e., access point, node, cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, a base station may comprise one access point or more than one access point. Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an eNodeB). In this regard, typically only one active uplink connection can occur per frequency. The base station may include one or more sectors served by individual transmitting/receiving components associated with the base station (e.g., antenna arrays controlled by an eNodeB). These transmitting/receiving components together form a multi-sector broadcast arc for communication with mobile handsets linked to the base station.

As used herein, “base station” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE), wherein the base station is not intended to be used while in motion in the provision of the service.

The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network.

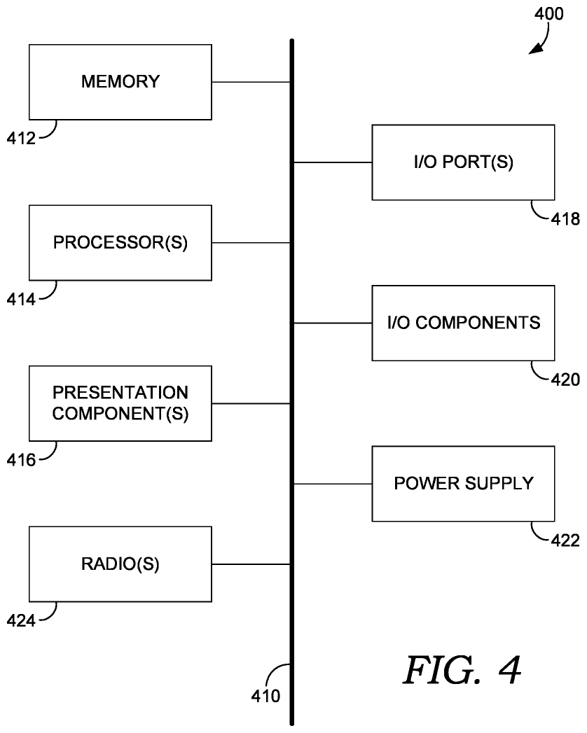

For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station or access point. A UE may be, in an embodiment, similar to device 400 described herein with respect to FIG. 4.

In conventional cellular communications technology, a RET label is a parameter file generated by operations support systems (OSS). The RET label comprises a RET angle value (i.e., e-tilt) with other information, such as antenna model name. The RET angle value can be applied to an antenna as e-tilt for coverage adjustment by OSS. However, the information is the RET label is manually entered, such as by a market engineer, and due to antenna swap or human error, may not be updated with the correct antenna model. As a result, the wrong antenna pattern assignment may be used by coverage prediction tools which may negatively impact coverage and unsupported e-tilt values.

The present disclosure is directed to enhancing 5G coverage optimization by enabling the node to automatically detect or determine an attached or installed antenna and report the antenna model name to an optimization engine. This empowers the optimization engine to provide real-time coverage predictions by leveraging dynamic updates to the RET label. To do so, a specific antenna model name for each antenna installed at the node is received at an optimization engine. The optimization engine automatically identifies a RET corresponding to each antenna. The antenna model name and the RET angle value for each antenna are dynamically associated in a data store. Based on the antenna model name and the RET angle value, the optimization engine can predict real-time coverage provided by the antenna. In some aspects, the optimization engine recommends an adjustment to the RET angle value that may be automatically applied by the node.

In a first aspect of the present invention, computer-readable media is provided, the computer-readable media having computer-executable instructions embodied thereon that, when executed, perform a method of enhancing 5G coverage optimization. The method comprises receiving, at an optimization engine, an antenna model name corresponding to an antenna supported by a node. The method also comprises identifying, at the optimization engine, a remote electrical tilt (RET) angle value corresponding to the antenna. The method further comprises dynamically associating the antenna model name and the RET angle value in a data store. The method also comprises, based on the antenna model and the RET angle value, predicting, at the optimization engine, real-time coverage provided by the antenna.

A second aspect of the present disclosure is directed to a method of enhancing 5G coverage optimization. The method comprises receiving, at an optimization engine, an antenna model name corresponding to an antenna supported by a node. The method also comprises identifying, at the optimization engine, a remote electrical tilt (RET) angle value corresponding to the antenna. The method further comprises dynamically associating the antenna model name and the RET angle value in a data store. The method also comprises, based on the antenna model and the RET angle value, predicting, at the optimization engine, real-time coverage provided by the antenna. The method further comprises recommending, by the optimization engine, an adjustment to the RET angle value.

Another aspect of the present disclosure is directed to a system for enhancing 5G coverage optimization. The system comprises a node and an optimization engine configured to wirelessly communicate with the node. Then optimization engine is configured to: determine one or more services being provided to the UE over a network; receiving, at a optimization engine, an antenna model name corresponding to an antenna supported by a node; identifying, at the optimization engine, a remote electrical tilt (RET) angle value corresponding to the antenna; dynamically associating the antenna model name and the RET angle value in a data store; and based on the antenna model and the RET angle value, predicting, at the optimization engine, real-time coverage provided by the antenna.

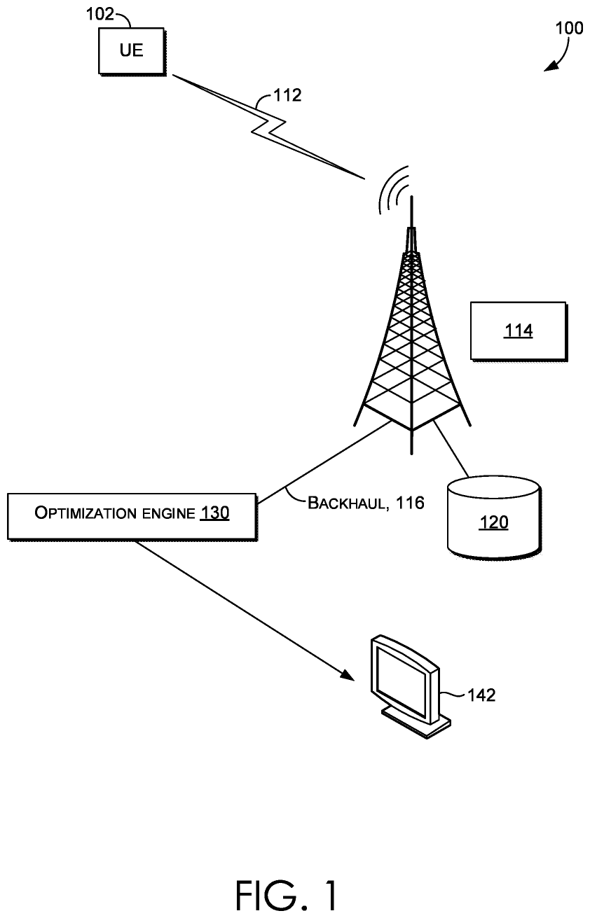

FIG. 1 depicts a wireless network environment incorporating an optimization system in which implementations of the present disclosure may be employed. Such a network environment is illustrated and designated generally as network environment 100. Network environment 100 is not to be interpreted as having any dependency or requirement relating to any one or combination of components illustrated.

Network environment 100 includes user device (UE) 102, access point 114 (which may be a cell site, base station, or the like), and one or more communication channels 112. In network environment 100, user device may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device (such as the computing device) that communicates via wireless communications with the access point 114 in order to interact with a public or private network.

In some aspects, UE 102 may correspond to computing device 400 in FIG. 4. Thus, a UE can include, for example, a display(s), a power source(s) (e.g., a battery), a data store(s), a speaker(s), memory, a buffer(s), a radio(s) and the like. In some implementations, for example, a UE 102 may comprise a wireless or mobile device with which a wireless telecommunication network(s) can be utilized for communication (e.g., voice and/or data communication). In this regard, the user device can be any mobile computing device that communicates by way of a wireless network, for example, a 3G, 4G, 5G, LTE, CDMA, or any other type of network.

In some cases, UE 102, in network environment 100 can optionally utilize one or more communication channels 112 to communicate with other computing devices (e.g., a mobile device(s), a server(s), a personal computer(s), etc.) through access point 114. The network environment 100 may be comprised of a telecommunications network(s), or a portion thereof. A telecommunications network might include an array of devices or components (e.g., one or more base stations), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure.

The one or more communication channels 112 can be part of a telecommunication network that connects subscribers to their immediate telecommunications service provider (i.e., home network carrier). In some instances, the one or more communication channels 112 can be associated with a telecommunications provider that provides services (e.g., 3G network, 4G network, LTE network, 5G network, NR, and the like) to user devices, such as UE 102. For example, the one or more communication channels may provide voice, SMS, and/or data services to UE 102, or corresponding users that are registered or subscribed to utilize the services provided by the telecommunications service provider. The one or more communication channels 112 can comprise, for example, a 1× circuit voice, a 3G network (e.g., CDMA, CDMA2000, WCDMA, GSM, UMTS), a 4G network (WiMAX, LTE, HSDPA), or a 5G network.

In some implementations, access point 114 is configured to communicate with a UE, such as UE 102, located within the geographic area, or cell, covered by radio antennas of access point 114. An access point 114 may include one or more base stations, base transmitter stations, radios, antennas, antenna arrays, power amplifiers, transmitters/receivers, digital signal processors, control electronics, GPS equipment, and the like. In particular, access point 114 may selectively communicate with the user devices using dynamic beamforming.

As shown, access point 114 is in communication with optimization engine 130 and at least a network database 120 via a backhaul channel 116. Access point 114 may store data, such as antenna model name of each antenna supported (i.e., installed) at access point and/or RET angle values corresponding to each antenna, at a network database 120. Alternatively, optimization engine 130 may automatically retrieve the data from access point 114, and similarly store the data in the network database 120. In some aspects, RET angle values corresponding to each antenna are provided by a market engineer, via computing device 142, to the network database 120 and/or the optimization engine 130. The data may be communicated or retrieved and stored periodically within a predetermined time interval which may be in seconds, minutes, hours, days, months, years, and the like. With the incoming of new data, the network database 120 may be refreshed with the new data every time, or within a predetermined time threshold so as to keep the status data stored in the network database 120 current.

The optimization engine 130 is generally configured to communicate with the access point 114, the network database 120, and/or the computing device 142 to enhance 5G coverage optimization. All data communicated to, received by, or further generated by the optimization engine 130 may be stored at the network database 120. In aspects, the optimization engine predicts real-time coverage provided by an antenna installed at the access point 114. In some aspects, the optimization engine 130 recommends an adjustment to the RET angle value of the antenna. For example, the optimization engine 130 may communicate instructions to the access point to automatically make an adjustment to the RET angle value of the antenna. In another example, the optimization engine 130 may communicate instructions to a market engineer, via the computing device 142, to make an adjustment to the RET angle value of the antenna.

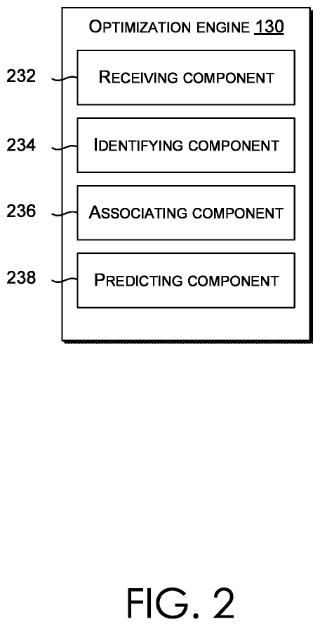

Referring now to FIG. 2, the optimization engine 130 comprises various components including a receiving component 232, an identifying component 234, an associating component 236, and a predicting component 238. Although the optimization engine 130 is shown as a single component comprising the receiving component 232, the identifying component 234, the associating component 236, and the predicting component 238, it is also contemplated that each of the receiving component 232, the identifying component 234, the associating component 236, and the predicting component 238 may reside at different locations, be its own separate entity, and the like, within the home network carrier system.

The receiving component 232 receives the antenna model corresponding to an antenna supported by (or installed at) the node. In some aspects, the antenna model name is automatically detected by the node when the antenna is installed (i.e., plug and play) and communicated to the receiving component 232. In other aspects, the node leverages an artificial intelligence (AI) driven algorithm to determine the antenna model name and communicates the antenna model name to the receiving component.

The identifying component 234 identifies a RET angle value corresponding to the antenna. In some aspects, the RET angle value is provided in a configuration file (i.e., the RET label) to the identifying component 234. In other aspects, the RET angle value is automatically provided to the identifying component 234 by the node.

The associating component 236 dynamically associates the antenna model name and the RET angle value in a data store. Based on the antenna model and the RET angle value, the predicting component 238 predicts real-time coverage provided by the antenna. In some aspects, the predicting component 238 recommends an adjustment to the RET angle value.

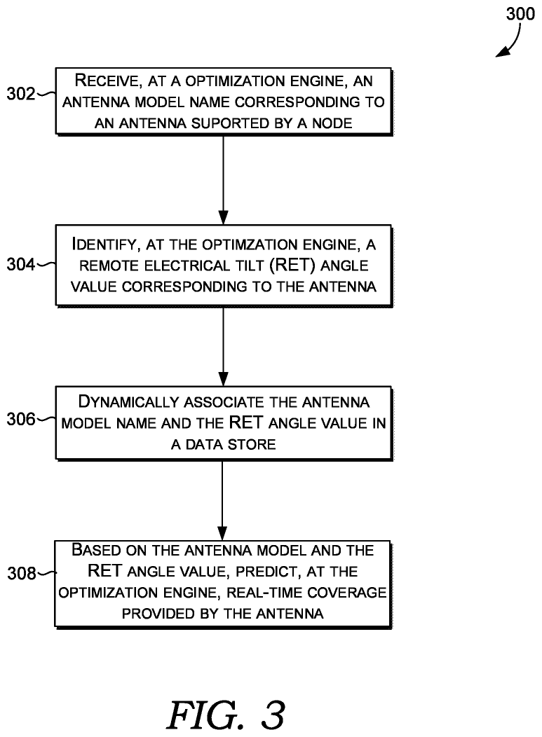

In FIG. 3, a flow diagram is provided depicting a method 300 for enhancing 5G coverage optimization, in accordance with aspects of the present invention. Method 300 may be performed by any computing device (such as computing device described with respect to FIG. 4) with access to optimization engine (such as the one described with respect to FIGS. 1 and 2) or by one or more components of the network environment described with respect to FIG. 1 (such as node 114 or optimization engine 130).

Initially, at step 302, an antenna model name corresponding to an antenna supported by (or installed at) a node is received. In some aspects, the antenna model name is automatically detected by the node when the antenna is installed (i.e., plug and play). In other aspects, the node leverages an artificial intelligence (AI) driven algorithm to determine the antenna model name.

At step 304, a remote electrical tilt (RET) angle value corresponding to the antenna is identified. In some aspects, the RET angle value is provided to the optimization engine in a configuration file. In other aspects, the RET angle value is automatically provided to the optimization engine by the node.

At step 306, the antenna model name and the RET angle value are dynamically associated in a data store. Based on the antenna model and the RET angle value, real-time coverage provided by the antenna is predicted, at step 308. In some aspects, an adjustment to the RET angle value is recommended. For example, the optimization engine may communicate instructions to the node to automatically make an adjustment to the RET angle value. In another example, the optimization engine may communicate instructions to a market engineer to make an adjustment to the RET angle value.

In some aspects, the receiving, detecting, updating, and predicting is initiated by the optimization engine based on a schedule. For example, the optimization engine may schedule the receiving, detecting, updating, and predicting to run on a weekly, daily, or hourly basis. In other aspects, the receiving, detecting, updating, and predicting is initiated by the optimization engine when an indication that a new antenna has been added to the node or a neighboring node has been received. In other aspects, the receiving, detecting, updating, and predicting is initiated by the optimization engine when an indication that a new node is added within a configurable radius of the node.

Embodiments of the technology described herein may be embodied as, among other things, a method, a system, or a computer-program product. Accordingly, the embodiments may take the form of a hardware embodiment, or an embodiment combining software and hardware. The present technology may take the form of a computer-program product that includes computer-useable instructions embodied on one or more computer-readable media. The present technology may further be implemented as hard-coded into the mechanical design of network components and/or may be built into a broadcast cell or central server.

Computer-readable media includes both volatile and non-volatile, removable and non-removable media, and contemplate media readable by a database, a switch, and/or various other network devices. Network switches, routers, and related components are conventional in nature, as are methods of communicating with the same. By way of example, and not limitation, computer-readable media may comprise computer storage media and/or non-transitory communications media.

Computer storage media, or machine-readable media, may include media implemented in any method or technology for storing information. Examples of stored information include computer-useable instructions, data structures, program modules, and other data representations. Computer storage media may include, but are not limited to, RAM, ROM, EEPROM, flash memory or other memory technology, CD-ROM, digital versatile discs (DVD), holographic media or other optical disc storage, magnetic cassettes, magnetic tape, magnetic disk storage, and/or other magnetic storage devices. These memory components may store data momentarily, temporarily, and/or permanently, and are not limited to the examples provided.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Referring to FIG. 4, a block diagram of an exemplary computing device 400 suitable for use in implementations of the technology described herein is provided. In particular, the exemplary computer environment is shown and designated generally as computing device 400. Computing device 400 is but one example of a suitable computing environment and is not intended to suggest any limitation as to the scope of use or functionality of the invention. Neither should computing device 400 be interpreted as having any dependency or requirement relating to any one or combination of components illustrated. It should be noted that although some components in FIG. 4 are shown in the singular, they may be plural. For example, the computing device 400 might include multiple processors or multiple radios. In aspects, the computing device 400 may be a UE/WCD, or other user device, capable of two-way wireless communications with an access point. Some non-limiting examples of the computing device 400 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 4, computing device 400 includes a bus 410 that directly or indirectly couples various components together, including memory 412, processor(s) 414, presentation component(s) 416 (if applicable), radio(s) 424, input/output (I/O) port(s) 418, input/output (I/O) component(s) 420, and power supply(s) 422. Although the components of FIG. 4 are shown with lines for the sake of clarity, in reality, delineating various components is not so clear, and metaphorically, the lines would more accurately be grey and fuzzy. For example, one may consider a presentation component such as a display device to be one of I/O components 420. Also, processors, such as one or more processors 414, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 412 may take the form of memory components described herein. Thus, further elaboration will not be provided here, but it should be noted that memory 412 may include any type of tangible medium that is capable of storing information, such as a database. A database may be any collection of records, data, and/or information. In one embodiment, memory 412 may include a set of embodied computer-executable instructions that, when executed, facilitate various functions or elements disclosed herein. These embodied instructions will variously be referred to as “instructions” or an “application” for short.

Processor 414 may actually be multiple processors that receive instructions and process them accordingly. Presentation component 416 may include a display, a speaker, and/or other components that may present information (e.g., a display, a screen, a lamp (LED), a graphical user interface (GUI), and/or even lighted keyboards) through visual, auditory, and/or other tactile cues.

Radio 424 represents a radio that facilitates communication with a wireless telecommunications network. Illustrative wireless telecommunications technologies include CDMA, GPRS, TDMA, GSM, and the like. Radio 424 might additionally or alternatively facilitate other types of wireless communications including Wi-Fi, WiMAX, LTE, 3G, 4G, LTE, mMIMO/5G, NR, VOLTE, or other VOIP communications. As can be appreciated, in various embodiments, radio 424 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 418 may take a variety of forms. Exemplary I/O ports may include a USB jack, a stereo jack, an infrared port, a firewire port, other proprietary communications ports, and the like. Input/output (I/O) components 420 may comprise keyboards, microphones, speakers, touchscreens, and/or any other item usable to directly or indirectly input data into the computing device 400.

Power supply 422 may include batteries, fuel cells, and/or any other component that may act as a power source to supply power to the computing device 400 or to other network components, including through one or more electrical connections or couplings. Power supply 422 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. One or more computer-readable media having computer-executable instructions embodied thereon that, when executed, perform a method of enhancing 5G coverage optimization, the method comprising:
receiving, at a optimization engine, an antenna model name corresponding to an antenna supported by a node;
identifying, at the optimization engine, a remote electrical tilt (RET) angle value corresponding to the antenna;
dynamically associating the antenna model name and the RET angle value in a data store; and
based on the antenna model and the RET angle value, predicting, at the optimization engine, real-time coverage provided by the antenna.

2. The media of claim 1, wherein the antenna model name is detected by the node.

3. The media of claim 1, further comprising, recommending, by the optimization engine an adjustment to the RET angle value.

4. The media of claim 3, further comprising, communicating, to the node, instructions to make an adjustment to the RET angle value.

5. The media of claim 3, further comprising, communicating, to a market engineer, instructions to make an adjustment to the RET angle value.

6. The media of claim 1, wherein the receiving is caused by the antenna being installed at the node.

7. The media of claim 1, wherein the receiving, detecting, updating, and predicting is initiated by the optimization engine based on a schedule.

8. The media of claim 1, further comprising receiving an indication a new antenna has been added to the node or a neighboring node.

9. The media of claim 1, further comprising receiving an indication when a new node is added within a configurable radius of the node.

10. The media of claim 1, wherein the RET angle value is provided to the optimization engine in a configuration file.

11. The media of claim 1, wherein the RET angle value is automatically provided to the optimization engine by the node.

12. A method of enhancing 5G coverage optimization, the method comprising:
receiving, at a optimization engine, an antenna model name corresponding to an antenna supported by a node;
identifying, at the optimization engine, a remote electrical tilt (RET) angle value corresponding to the antenna;
dynamically associating the antenna model name and the RET angle value in a data store;
based on the antenna model and the RET angle value, predicting, at the optimization engine, real-time coverage provided by the antenna; and
recommending, by the optimization engine, an adjustment to the RET angle value.

13. The method of claim 12, wherein the antenna model name is detected by the node.

14. The method of claim 12, further comprising, communicating, to the node, instructions to make an adjustment to the RET angle value.

15. The method of claim 12, further comprising, communicating, to a market engineer, instructions to make an adjustment to the RET angle value.

16. The method of claim 12, wherein the RET angle value is provided to the optimization engine in a configuration file.

17. The method of claim 12, wherein the RET angle value is automatically provided to the optimization engine by the node.

18. A system for enhancing 5G coverage optimization, the system comprising:
a node; and
an optimization engine configured to wirelessly communicate with the node, wherein the optimization engine is configured to:
determine one or more services being provided to the UE over a network;
receiving, at a optimization engine, an antenna model name corresponding to an antenna supported by a node;
identifying, at the optimization engine, a remote electrical tilt (RET) angle value corresponding to the antenna;
dynamically associating the antenna model name and the RET angle value in a data store; and
based on the antenna model and the RET angle value, predicting, at the optimization engine, real-time coverage provided by the antenna.

19. The system of claim 18, wherein the antenna model name is detected by the node.

20. The system of claim 18, further comprising, recommending an adjustment to the RET angle value.
